(19) United States
(12) Patent Application Publication
(10) Pub. No.: US 2020/0265446 A1
(43) Pub. Date: Aug. 20, 2020

(54) FOOD CHAIN PRODUCT LABEL AND METHOD OF USE, AND FOOD TRUST IDENTIFIER SYSTEM

(71) Applicant: AVERY DENNISON RETAIL INFORMATION SERVICES, LLC, Mentor, OH (US)

(72) Inventor: Julie Vargas, San Antonio, TX (US)

(21) Appl. No.: 16/791,636

(22) Filed: Feb. 14, 2020

Related U.S. Application Data
(60) Provisional application No. 62/805,669, filed on Feb. 14, 2019.

(51) Int. Cl. G06Q 30/00; G06Q 10/08; G06K 7/14; G06K 7/10

(52) U.S. Cl. CPC G06Q 30/018; G06Q 10/087; G06K 7/10297; G06K 7/1417; G06K 7/1413

(57) ABSTRACT

A blockchain-based “food chain” system and method for tracking products such as RFID labels and associating them with other products. Such a method may ensure authenticity at each step, ensuring that the digital identity of a physical item can be accurately verified. The method may include receiving and verifying integrated circuit chips manufactured by a trusted supplier, assembling the chips into a roll inlay, assembling these into a carton and pallet and updating the blockchain with roll, carton, and pallet codes, taking receipt from a specific trusted individual and adding verification to the blockchain, and activating a digital identity. GPS information may be associated with every step in order to ensure that the product is properly present at certain manufacturing and encoding locations. Once a digital identity is produced for the product, it may be added to an associated blockchain, and additional information may further be added by subsequent use.

### CROSS REFERENCE TO RELATED APPLICATION(S)

This application claims priority to and the benefit of U.S. Provisional Patent Application Ser. No. 62/805,669 filed on Feb. 14, 2019, which is incorporated herein by reference in its entirety.

### BACKGROUND

The present invention relates generally to a blockchain based “food chain” system and method of use for tracking products such as RFID labels and associating the same with other products to create a digital identity. More particularly, the present invention relates generally to use of such systems with a food trust identifier system.

Businesses have often struggled with the practice of tracing products from their point of origin all the way to retail. The inability of businesses to do this can often lead to significant cost expenditures, particularly when some sort of problem is identified with a small number of products that forces the business to issue a massive recall or freeze sales until all noncomplying products can be taken off the shelves.

Some of the best examples of this come from the field of food safety. New food safety laws have given the federal government a great deal of additional latitude to enforce recalls on certain food products. Likewise, new practices by physicians and public health officials have made it much easier to identify the source of a particular outbreak. As a result, both the Food and Drug Administration and the U.S. Department of Agriculture have recalled food at ever-increasing rates starting in 2012. These recalls can often be extremely major; for example, in April of 2018, the Food and Drug Administration announced a recall of 206 million eggs over salmonella-contamination concerns, affecting numerous retailers including Walmart® and Food Lion®. Likewise, these recalls can be extremely frequent; in summer 2018, products including Ritz® crackers, Goldfish® and Swiss Rolls™ were all recalled in one week, and McDonald's® salads and Kellogg's® Honey Smacks™ were also subject to recall just a little while beforehand. (In most cases, this is because the products were linked to salmonella outbreaks.)

Some extremely disruptive recalls have come about under circumstances where it is more difficult to identify the specific source of the outbreak or whatever other problem has led to the recall. For example, in 2006, a major E. coli outbreak occurred that infected almost 200 people, with the bacteria being spread by contaminated spinach. It took around two weeks to identify which farm had been selling the spinach, and, as a result, for about two weeks, retailers stopped selling spinach all over the United States until the farm that caused the outbreak was identified. This created a significant loss of revenue for all retailers selling spinach and for all the farmers that grew it and meant that many customers who had previously bought some of the contaminated spinach and were not aware of the recall still could potentially become sick.

One of the reasons why it typically takes so long to identify the source of a contaminated product, such as a food product, is due to the complicated supply chain process that is managed by a network of growers, wholesalers, distributors and retailers, almost none of whom had information about their entire supply chain readily available. More specifically, electronic data generally only makes it one or two steps downstream in the supply chain. For example, a retailer might know who its distributor is, but not the ultimate source of the product, and a distributor might know the identity of its supplier, but not the identity of the supplier's supplier, all of which generally must be identified manually. The problem is further complicated when one takes into consideration the extremely high number of products and locations that some of the larger retails possess. For example, retailers like Walmart have over 50,000 products on the shelves at more than 6,000 different store locations, sourced from thousands of vendors, thereby making the tracking of products a logistical nightmare. As such, even highly sophisticated retailers can take around a week or more to identify the origin of a product even under the most dire of circumstances.

Additionally, as grocery stores and other food providers are increasingly going digital with respect to their shipping, receiving, and inventory, there are related complexities associated with supply chains, store formats and shopping strategies. Consumers are demanding more information related to food products and more visibility with respect to food products on sale and consumed. Further, there are increasing demands and requirements regarding food safety and food waste.

Of course, the food and beverage industry is not the only industry in which businesses may need to trace their products to their point of origin or destination. Another example of an industry with such a need is the transportation industry, and particularly the airline industry. For example, if an aircraft experiences some kind of catastrophic failure, such as a turbine explosion, it can be extremely important to quickly identify the point of origin for the component so that, if the part failed due to some sort of manufacturing defect, any other similar components can be quickly identified and taken out of service, thereby preventing further catastrophes from occurring. This can also be an issue with many other types of machine parts, from consumer goods to industrial equipment, though aircraft and other transportation vehicles have some of the highest risks of catastrophic failure leading to significant loss of life.

Additionally, faulty or defective components can be extremely difficult to identify and source. For example, individual components may not be separately marked with identifying information, and, oftentimes, manufacturers of each successive component in a chain (for example, an individual fan blade, the other components of a turbine assembly, an engine, and an aircraft as a whole may all have different manufacturers) may not have information on the sources of every other component in their assembled products. As a result, attribution of fault after an accident is made much more difficult. Likewise, the procedures that must be undertaken in order to ensure the safety of such components are made much more complex and expensive than they might otherwise have been with an appropriate tracking system in place.

Finally, product tracking concerns are no just limited to the businesses in the product supply chain. Customers, with good reason, may have greater peace of mind if they can be assured that the products that they have purchased are not subject to recall anywhere, and have been safely vetted at every stage of the production process. This has become an issue of increasing concern for customers due to the relatively high number of counterfeit or poor-quality goods manufactured abroad, which have contributed to a large number of health scares in the United States. For example, in one year, toy maker Mattel® had to recall nearly one million toys due to the use of lead paint in certain foreign factories, toy train manufacturer Rc2 had to recall 1.5 million toys for the same reason, half a million radial tires were recalled by an American distributor after a safety feature was unilaterally eliminated by a foreign factory, and—in the scandal that attracted the most news—Spin Master's™ Aqua Dots products contained a toxic contaminant that hospitalized a number of children. As such, many customers are clamoring for a way to guarantee that the products they purchase are authentic and free of harmful substance and other defects.

Customers also have an interest in ethical sourcing of products or the use of sustainable manufacturing practices, which has resulted in customers preferring ethical and/or sustainable products. Further, this customer preference has resulted in increased brand loyalty toward companies that can guarantee that they are engaging in sustainable practices and ethical sourcing.

Therefore, there is a long felt need in the art for the ability to better track products, and the various components contained therein, from point of origin to retail and beyond. There is also a long felt need in the art for a blockchain-based “food chain” system and method that creates a digital identity for a product that enables a user to accurately verify the digital identity of the product throughout the process. More specifically, the system and method may include use of authorized identifications for a product to enhance data integrity of such a system and method. Such authorized identifications associated with a particular product or entity may be added to a ledger associated with the product and/or the entity.

### SUMMARY

By way of background, a blockchain is a growing list of records, called blocks, that are linked using cryptography. More specifically, each block preferably contains a cryptographic hash of the previous block, a timestamp, and transaction data. By design, a blockchain is resistant to modification of the data. It is an open, distributed ledger that can record transactions between two parties efficiently and in a verifiable and permanent way. For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority.

One application of blockchain technology comes in the form of product tracking. More specifically, blockchain can be used to establish the point of origin for a particular product, and can also be used to trace the product throughout its useful life while enabling a clear transfer of ownership to take place at each stage of the product's lifecycle. Anyone with access to the blockchain associated with a particular product may be able to identify a point in the product's history indicating where the product came from, who owned it last, and so forth, provided that some effective technique is established for guaranteeing that the blockchain is updated at every step.

However, there are certain problems with attempting to use blockchain in this manner. More specifically, a blockchain record is, by necessity, electronic, so if the electronic record cannot be effectively associated with the physical product, it is of limited use. Likewise, if it cannot be guaranteed that the blockchain record will actually be updated every time the product changes hands, it is ineffective at establishing an accurate record of the supply chain.

One solution for ensuring that blockchain record information remains associated with the product in question, and for ensuring that the blockchain record information is accurately updated, comes from radio-frequency identification (RFID) technology. Generally stated, radio-frequency identification is the use of electromagnetic energy to stimulate a responsive device (known as an RFID “tag” or transponder) to identify itself and, in some cases, provide additional information and/or data stored in the tag. RFID tags typically comprise a semiconductor device commonly referred to as the “chip”, upon which are formed a memory and an operating circuitry, which is connected to an antenna. Typically, RFID tags act as transponders, providing information stored in the chip memory in response to a radio frequency interrogation signal received from a reader, also referred to as an interrogator. In the case of passive RFID devices, the energy of the interrogation signal also provides the necessary energy to operate the RFID tag device.

RFID tags may be incorporated into or attached to articles that a user wishes to later identify and/or track. In some cases, the RFID tag may be attached to the outside of the article with a clip, adhesive, tape, or other means and, in other cases, the RFID tag may be inserted within the article, such as being included in the packaging, located within the container of the article or plurality of articles, or sewn into a garment. Further, RFID tags are manufactured with a unique identification number which is typically a simple serial number of a few bytes with a check digit attached. This identification number is typically incorporated into the RFID tag during its manufacture. The user cannot alter this serial/identification number, and manufacturers guarantee that each RFID tag serial number is used only once and is, therefore, unique. Such read-only RFID tags typically are permanently attached to an article to be identified and/or tracked and, once attached, the serial number of the tag is associated with its host article in a computer database.

According to an exemplary embodiment of a food chain system, RFID technology can provide a unique identifier that can be mapped to a product, thereby allowing the supply chain to become more efficient, saving time and increasing inventory accuracy. As such, an end-to-end system can be implemented that leverages RFID technology to establish a unique identifier, verify the digital identity of a physical item, and associate the digital identifier with the physical item. The system may then, in certain exemplary embodiments, include additional features directed at ensuring that the data associated with the blockchain is trustworthy. Such unique identifiers may be related to specific digital ledgers, such as the IBM Food Trust, and platforms associated with various entities. Further, when it comes to the maintenance of such a record, the “garbage in, garbage out” principle applies, such that, if the digital identity creation, association, and/or activation of the physical item—initially or at each successive stage in the supply chain—is not trusted, then the downstream blockchain application could be compromised.

A “food chain” system may also function to provide a “truth” layer to users by combining RFID technology and biometrics. For example, according to one embodiment of a food chain, a “food chain” may have several “prongs,” each belonging to a separate chain that may be validated and connected to a particular brand owner chain, which may then be connected to a retailer chain. As such, a “food chain” may be a blockchain derivative, wherein only a small number of people add to a collective ledger; the more limited “food chain” may specifically service a particular brand, particular retailer, or any other type of entity to suit user need and/or preference.

According to an exemplary embodiment, the overall process by which a food chain system may be implemented may be broadly understood as having four main steps, though in some exemplary embodiments, these four steps may be subdivided into smaller steps, and may be performed simultaneously or in any order, such as may be desired.

In a first step, the labels that may be used alongside a food chain system may be manufactured. To manufacture the authenticated labels, the underlying RFID circuits may be manufactured by a trusted supplier, based on any method as would be understood in the art. As these RFID circuits are assembled, certain records relating to the manufactured circuits may be integrated into a blockchain by the chip supplier, including any or all of: (a) the batch identifier (“ID”) of each of the chips; (b) the wafer ID; (c) the unique tag identification memory associated with and containing data about each chip (which may, in Gen 2 RFID tags, be referred to as a “TID”); (d) the unique brand identifier associated with the chip supplier; and (e) a variable counter associated with the RFID chip and indicating its position in a production run. Other data may also be stored on the blockchain related to the RFID chip, which may be provided along with the RFID chip to the RFID chip recipient from the trusted RFID chip supplier.

Once the chips have been manufactured, and have been delivered from the chip supplier, the chips may then be integrated into label rolls. It is also contemplated that each of these steps may be performed by the same entity or by different entities, such as may be desired. For example, RFID labels may be manufactured into rolls such that the chips are integrated into each label on the roll. As part of this manufacturing process, additional information may be added to the blockchain for each RFID tag or chip in each label on the roll. Such additional information may include, for example, a unique roll ID for each roll of labels, an indication of whether the chip or label has been tested as being functional or nonfunctional (i.e., “good” or “bad”) or whether the chip or label has been tested as having an acceptable degree of functionality if multiple degrees of functionality are required, as well as any other information that may be necessary in order to account for all of the chip devices used in the manufacturing of the labels. It is also contemplated that the chips may be tested prior to their integration with the labels, such that functional chips can be identified and used, and such that nonfunctional chips can be identified and properly disposed of. Additionally, each blockchain associated with each chip may be updated, such that the blockchains associated with defective or nonfunctional chips identify those chips as defective or nonfunctional. This may potentially allow the supplier to identify defects, or may allow for variable and dynamic compensation to be provided to the supplier in real time based on the failure rates of their devices, or other such configurations such as may be desired.

Once the RFID labels are manufactured in the form of rolls, they may be assembled into cartons, which may then be assembled into pallets, which may then become the final product shipped to a customer and eventually combined with the end products to be tracked. Accordingly, the RFID tags (or other integrated circuit devices) may be associated with a roll ID associated with the roll of the RFID tag label, which may be mapped to a particular carton ID based on the carton to which the roll has been added, which may in turn be mapped to a particular pallet ID based on the pallet to which the carton was added. According to an exemplary embodiment, the addition of these values to the blockchains associated with each RFID tag may allow information about the RFID tag to be tracked back to the initial chip ID and wafer ID, should it become necessary to verify the production process of the chip all the way back to the trusted manufacturer or supplier of the RFID labels. This lookup process may likewise be usable in a reverse fashion, such that a roll ID may be associated with a specific set of integrated circuits on the roll, thereby allowing the roll ID to be used in order to identify exactly which RFID chips have been used to form that roll of labels. If, for example, a roll has a particularly high defect rate, the defect rate may be identified and traced back to the supplier or manufacturer of the roll. Likewise, if a roll has a particularly low defect rate, the process allows that supplier to be identified and prioritized for future orders or may allow future specifications to be created or updated for other suppliers to match that target.

Once all such identifiers have been associated with the blockchains associated with each label, a shipment ID may be created corresponding to a particular shipment. According to an exemplary embodiment, a pallet ID, a case ID, and/or a roll ID may be mapped with a shipment ID (or “ship to” ID), which may combine the pallet, case, and/or roll information with shipment information for a particular customer. Alternatively, as previously mentioned, such a procedure may be performed by one actor performing multiple steps, such that, for example, the same company is producing and then using the labels. In such an exemplary embodiment, a shipment ID may instead identify a shipment location, such as a production facility in which the labels will be used, such as may be desired.

Once the customer or other recipient has received the labels, the customer may verify receipt of the labels through the blockchains associated with each label. Verification ensures that the production and shipment history of the label is fully traceable from the initial stages of production of the chip to the customer of the label. It is also contemplated to have situations wherein the labels are only partially completed, or are finished elsewhere, which may also be specified in the production and shipment history of the label. For example, blank labels, intended to be printed upon later or intended to be integrated within a product without any sort of printing being applied thereto, may be provided to one customer, while in another case it may be desired to have the labels printed upon and encoded before shipment. In such cases, wherein the labels may be printed and encoded prior to shipment, additional information such as the electronic product code (EPC) of the RFID tag may be integrated with the blockchain at this stage such as may be desired. For example, the EPC may be added to the label blockchain ledger prior to the label being associated with a roll ID, a case ID, and so forth.

Once the customer (or production facility or other destination) has received the rolls of labels, the second step of the method may begin. In an exemplary embodiment of a food chain system, the location to which the RFID labels were shipped may first be integrated into the blockchain ledger for each label. The location information may be, for example, a GPS location of the facility or a mailing address, or any other geographical identifier such as may be desired. Alternatively, only a simple identifier such as “Location 1” or “LOC_1,” “LOC_2,” “LOC_3,” and so forth may be added, such as may be desired. As provided here, location information may generally be referred to as an identifier for “LOC_N,” which may or may not contain detailed information, such as GPS information or other absolute coordinate information, address information or other relative location information, and so forth. It is also contemplated that the customer may have multiple locations in which the pallets of labels may be shipped. For example, if the customer has a variety of end location to which the labels may be shipped, the shipment of the labels to these locations may be tracked via blockchain, and each of the customer's locations may host a secure node that may be used to read the product and verify the receipt of the product and the location of its receipt.

Once the pallet has reached the end location, it also may be desirable to have a specific employee or agent of the company responsible for inspecting the RFID labels and updating the blockchain ledgers associated with each RFID label. According to an exemplary embodiment, it may alternatively be useful to have a set of authorized employees or agents of the customer or other recipient, or specific devices of the customer (for example, if the customer has an automated receipt process), which may be able to update the blockchain ledgers, as may be desired. In an exemplary embodiment, a blockchain ledger may be updated to show the identifying information for a particular authorizing employee or agent, which may update the ledger to show, for example, “Received by ______” or “Received—Employee 306.” In such an exemplary embodiment, once the case ID, pallet ID, and/or roll ID is received, one or more of the identifiers (such as a roll ID) may be transferred to this individual ID for the employee or agent such that the roll ID or other identifier can be tracked via blockchain. The individual label IDs may also be directly transferred or may be updated directly to include this employee ID information or may instead simply inherit it from the roll ID information or other identifying information.

Once this individual receives the assigned or commissioned roll ID, the food chain system may require authenticating information be added to the blockchain ledger from the individual. For example, according to an exemplary embodiment, the individual may be provided with a biometric scanner or other biometric information to enable the individual to enter his or her thumbprint, for example, to receive delivery of the rolls, generate a code with the biometric information and optionally other information, such as the date and time of receipt, and all of such information may be added to the blockchain ledger for each label (or may be associated with specific IDs such as the roll IDs) as may be desired. Other authentication methods other than, or in addition to, biometrics are also contemplated. For example, in one exemplary embodiment, an individual may provide an encrypted electronic signature to the blockchain ledger to ensure that the RFID labels are provided to a specific accountable individual that can verify himself or herself as an employee or agent through the customer company through whatever authentication measures may be appropriate or desired. Other examples may include a two-factor or encrypted authentication on the chip and/or inlay. These could include binary encryption layers in the chip or other component provided on the inlay, such as a sensor or other trigger.

The third step of the method involves the trusted application of the label to a particular product at the point of use. According to an exemplary embodiment of a food chain system, once a specific roll ID ownership value is assigned or transferred to an individual ID, the individual may then encode certain further information on the blockchain ledgers, optionally with specific hardware, and optionally after performing certain other actions such as may be desired.

For example, according to an exemplary embodiment of the food chain system, an individual may first use a dedicated hardware system (or other system) in order to verify the accuracy of each roll ID, as well as any other details stored on the blockchain. For example, the same dedicated hardware system also may be used in order to perform chip testing, such as may be desired, and each RFID tag encoded in each label, or some appropriate selection of RFID tags in the label roll, may be tested in order to ensure that the RFID tags can be properly read. Damaged or defective RFID tags may be removed from the process and the blockchain updated accordingly.

According to an exemplary embodiment, a customer hardware system may incorporate a printer, which may be used to print any variable information on the labels that may be desired. For example, if the labels are blank, the printer may be used to print any and all information on the labels that it may be desired for the labels to have. Alternatively, variable information may be printed on just a portion of the labels in order to supplement unchanged information provided on the labels since the previous step, if the labels were prepared in this manner in the previous step. In a further exemplary embodiment, the label printer used by the customer may be connected to an encoder or another hardware device configured to record the variable data in the blockchain ledgers.

According to an exemplary embodiment, a customer hardware system may further include an encoder, which may be used to encode information in the RFID tag of the label. The encoder may be provided before or after the printer or may be provided concurrently with the printer in that some printer tasks may be performed beforehand or afterward. For example, RFID labels may be printed upon, encoded, and separated from the web if provided in a continuous format, such as may be desired. The encoded information then may be stored in the blockchain ledger in some form. For example, all of the encoded information may itself be stored in the blockchain ledger, which may allow for the information to be easily accessed by tracing the product's history. In another exemplary embodiment, only a selection of the encoded information, or an indication that the information has been successfully encoded, may be stored in the blockchain such as may be desired.

According to an exemplary embodiment, the customer hardware system also may include a location encoder, which may encode the location at which the label was printed and encoded. The location encoder may be part of the encoder, or may be a separate device, such as may be desired. According to an exemplary embodiment, the location encoder may make a live retrieval of the current location with every encoding (for example, via GPS or other geo-location technologies, such as may be desired) or may encode a predetermined location such as may be desired. For example, in one exemplary embodiment, the address of the factory may be encoded; whereas in another exemplary embodiment, a pre-recorded GPS coordinate or other location indication may be encoded without such location being checked first. The encoded location then may be added to the blockchain, along with the other information associated with the RFID label, in such a manner as to tie it to both the roll ID (and/or the individual label ID) and the individual ID of the customer employee or agent.

According to an exemplary embodiment, it is also contemplated to have a combination printing and encoding machine, or a machine that performs some combination of printing and encoding, such as may be desired. The combination printing and encoding machine may perform the functions of printing, data encoding, and/or location encoding after verifying the individual ID and the roll ID to ensure that each was proper.

According to an exemplary embodiment, it is also contemplated that a customer may be making use of already printed labels (e.g., printed labels that have not yet been encoded), already encoded labels (e.g., encoded labels that have not yet been printed or which do not feature a finalized print), and/or labels that have already been printed and encoded. In some exemplary embodiments, it is contemplated that printing and encoding may be performed as a part of the manufacturing of the roll, if desired. Alternatively, it is contemplated that a service bureau or other intermediate company may perform the labeling, encoding, and/or printing, such as may be desired. Should a service bureau perform any of the intermediate steps, such information may be indicated on the blockchain in a similar matter to the method previously discussed to ensure full accountability at each step in the process. In such an embodiment, the customer may complete the labels as necessary, and then provide additional location encoding, indicating that the labels have been received in whatever form they have been received in, and indicating that the labels have been modified and added to the products as appropriate.

Once the customer (or, again, other production location, such as may be contemplated) has completed the printing and encoding process, an authorized individual at the customer (who may be, for example, a trusted employee or agent of the manufacturing company) may apply the digital identity to the physical product. In one exemplary embodiment of a food chain system, the rolls may be fully traceable up until this point, with the rolls being assigned to this employee and validated by the printer and encoder machine node. After this point, the focus may be on the individual RFID labels, as the labels may be applied to the actual physical products with which they will be associated, and incorporating such information into the blockchain ledger associated with each product. Chain of custody protocols could also be used to ensure that all the RFID labels are accounted for as part of the process to maintain integrity of the system. User IDs, hardware encryption, or other authentication details can also be used.

In a fourth step of the method, in order to ensure that the physical products are properly associated with the RFID tag and with the blockchain ledger associated with that RFID tag, an exemplary embodiment of the food chain system may have a process for incorporating the two. For example, once a particular physical product is assigned a specific RFID label, or during the manufacturing process, a final time stamp may be applied to the blockchain ledger associated with the RFID tag of the label, corresponding to the time at which the tagged product was scanned and read during the manufacturing process or a time immediately after labeling. This final timestamp may provide for the traceability of the RFID label all the way back through the label supply chain, to the first production of the integrated circuits.

Once this has occurred, the manufacturer may, upon reading the tagged product and time stamp, create a verification report so as to provide the product with a cohesive digital identity. For example, according to an exemplary embodiment, a verification report may include verification of one or more of, or all of, the following: (a) that the labels have come from a trusted source; (b) that the commissioned RFID labels have been provided to the correct manufacturing location; (c) that the RFID labels have been updated by a trusted employee or agent; (d) that the RFID labels have been properly encoded at a defined location; (e) that the RFID labels have been applied to a product at a defined location (e.g., by geolocation or otherwise) as overseen by the trusted employee or agent; and (f) that the product's digital identity has been finalized and activated for downstream supply chain uses.

According to an exemplary embodiment, once this persistent digital identity has been created, others may be able to add to the blockchain ledger associated with a particular product, as desired or to suit user preference. For example, once the product has an activated digital identity, it may be updated with timestamp and location information showing that it has been provided to a retailer, timestamp and location information of an original purchase by a first party, information showing that the first party donated the product to, for example, a consignment store, information showing that it was then purchased from the consignment store by a second party, and so on and so forth. In some cases, a product having a digital identity may be updated other than when it changes hands. For example, in an exemplary embodiment, a digital identity of a product may be updated if it is returned or exchanged (e.g., if it is clothing of an improper size), or may even be updated when it is taken to particular places (e.g., a user that travels to a foreign country may have their products “check in” in those foreign countries to show where they have previously been).

In an exemplary embodiment, the blockchain ledger associated with a particular RFID tag in a label may be combined with a pre-existing blockchain associated with a product, or with any other component of the process. For example, a particular product may be designated by a blockchain ledger associated with the raw materials used to make the product (e.g., fabric used to make clothing, or Fair Trade Certified™ products and ingredients used in a food or beverage product). Further, companies providing transportation or providing other labor may also have their own blockchain ledgers indicating what was done when, which may be reconciled with the blockchain ledger of the RFID tag and/or of the raw materials.

According to an exemplary embodiment, one or more specific prongs of a food chain ledger may be the material chain, which may guarantee that ingredients or other components are Fair Trade Certified™, have been sourced from non-conflict regions, are made from sustainable materials, use recycled or recyclable materials in the packaging, and so forth. Each of these components may be validated/verified with RFID to provide for the integrity of the source. One or more other prongs of the food chain may be a farm prong, used to identify that the farm or farms from which one or more ingredients of the final food product is made are not farms that have been linked to any outbreaks, use ethical farming techniques, are across-the-board organic, use particular diets for livestock and/or poultry, the particular location of the farm or farms (for considerations about local sourcing), etc. Another prong of the food chain may pertain to the source of the labor used to create the product, wherein the labor source is validated to be free of child labor, to have safe working conditions, food, shelter, reasonable hours, etc. Yet another prong of the food chain may relate to transportation, which may, for example, identify that the carriers have not been implicated in illegal activity, such as illegally flagged vessels, or may identify that the carriers do not (or do, depending on preference) support boycotts against particular countries.

In one exemplary embodiment, the use of the “food chain” may allow products which involve particular companies somewhere in the supply chain to be marketed in specific locations or to specific target demographics. For example, if it is desired to sell a product in a heavily political area, a shipping company may be selected that has made a high-profile endorsement of a particular politician, and the “food chain” system may ensure that that shipping information is associated with a specific product to be sold in that area. Meanwhile, in another area, another company could be selected for the contract.

According to further aspects of the present disclosure, a method for tracking an item comprises storing information on one or more objects, associating the one or more objects with the item, and adding the information to one or more ledgers associated with the item. In some embodiments, at least one of the one or more ledgers is associated with one or more entities. In some embodiments at least one of the one or more ledgers is an open or public blockchains. In some embodiments at least one of the one or more ledgers is a permissioned blockchain. In some embodiments, the one or more objects comprise auto-identification and data capture technologies, which may be selected from the group consisting of radio-frequency identification (RFID) tags, barcodes, QR codes, data matrix codes, and digital watermarks. In some embodiments, the method further comprises obtaining the information stored on the one or more objects. In some embodiments, the obtaining step comprises one or more of interrogating an RFID tag, scanning a barcode, scanning a QR code, scanning a data matrix code, or scanning a digital watermark.

In some embodiments, the associating step comprises securing an RFID tag to the item or packaging associated with the item. In some embodiments, the RFID tag is part of an RFID label further comprising printed indicia comprising one or more of a barcode, a QR code, a data matrix code, or a digital watermark. In some embodiments, the method further comprises storing redundant information on the RFID tag and the one or more barcode, QR code, data matrix code, or digital watermark. In some embodiments, the RFID tag contains at least some information not contained on the one or more barcode, QR code, data matrix code, or digital watermark. In some embodiments the one or more barcode, QR code, data matrix code, or digital watermark contains at least some information not contained on the RFID tag.

In some embodiments, the information stored in the one or more objects comprises one or more authorized identifications associated with one or more of the item and one or more entities. In some embodiments, the method further comprises procuring at least one of the authorized identifications from a system database. In some embodiments, the method further comprises creating at least one of the authorized identifications to generate at least one new identification. In such embodiments, the method may further comprises obtaining approval to use the at least one new identification. In some embodiments, the method further comprises sharing the at least one new identification with system users. In some embodiments, the method further comprises adding the at least one new identification to a system database.

According to other aspects of the present disclosure, a system for tracking an item comprises one or more objects associated with the item, one or more authorized identifications stored in each of the one or more objects, and one or more ledgers associated with the item. In some embodiments, the one or more objects comprise auto-identification and data capture technologies, which may be selected from the group consisting of radio-frequency identification (RFID) tags, barcodes, QR codes, data matrix codes, and digital watermarks. In some embodiments, at least one of the one or more objects comprises an RFID label including an RFID tag. In some embodiments, the system further comprises an RFID reader configured to interrogate the RFID tag. In some embodiments, the RFID label further comprises printed indicia comprising at least one of a barcode, a QR code, a data matrix code, or a digital watermark. In some embodiments, the system further comprises a scanner configured to scan at least one of the barcode, QR code, data matrix code, or digital watermark.

In some embodiments, at least one of the one or more authorized identifications are stored in a system database. In some embodiments, the system further comprises an administrator responsible for managing the database. In some embodiments, the one or more authorized identifications are standardized according to defined protocols. In some embodiments, the administrator is responsible for defining protocols to standardize authorized identifications. In some embodiments, a system user may request a new authorized identification and the administrator is responsible for approving the new authorized identifications. In some embodiments, the administrator is responsible for resolving redundancies and/or ambiguities in the database, including redundancies and/or ambiguities in the authorized identifications.

In some embodiments, the system further comprises a computer network. The computer network may be configured to add at least one of the one or more authorized identifications to at least one of the one or more ledgers associated with the item.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a structure diagram showing a combined food chain system;

FIG. 2 is an exemplary embodiment of a process flow diagram for the manufacturing of an RFID-equipped label;

FIG. 3 is an exemplary embodiment of a map showing the geographic location information associated with a food chain ledger, which may be accessible by a user using a user interface;

FIG. 4 is an exemplary embodiment of a process flow diagram for a food chain system in accordance with the disclosed architecture;

FIG. 5 is an exemplary embodiment of a process flow diagram for a verification system in accordance with the disclosed architecture; and

FIG. 6 is an exemplary embodiment of a process flow diagram for a food chain system in accordance with the disclosed architecture.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

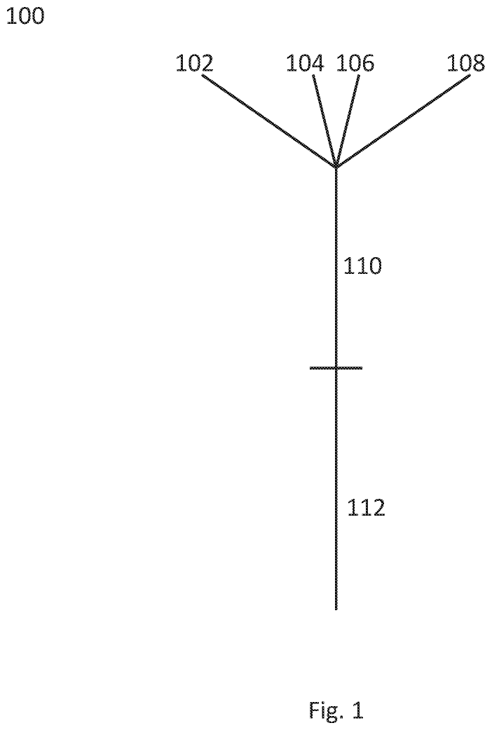

Referring now generally to the Figures, various exemplary implementations of a food chain system and method of use are disclosed herein. More specifically, FIG. 1 displays an exemplary embodiment of a structure diagram showing a combined food chain system 100. As stated above, a food chain system 100 may have several “prongs,” each belonging to a separate blockchain that may be validated and connected to a particular brand owner chain, which may then be connected to a retailer chain. As such, a “food chain” may be a blockchain derivative, wherein only a small number of people add to a collective ledger; the more limited “food chain” may specifically service a particular brand, particular retailer, or any other type of entity to suit user need and/or preference. In an exemplary embodiment, the blockchain ledger associated with a particular RFID tag in a label, such as blockchain ledger 102, may be combined with a pre-existing blockchain associated with a product, or with any other component of the process. For example, it may be contemplated to have an additional blockchain ledger associated with the raw materials or ingredients used to make the product (e.g., fabric used to make clothing or cacao used to make a chocolate bar) 104, a blockchain ledger associated with transportation services 106, and a blockchain ledger associated with manufacturing labor 108, as best illustrated in FIG. 1. Each of the blockchain ledger components 102, 104, 106, and 108 may incorporate specific information regarding their history and the locations at which each event in the history occurred. For example, according to an exemplary embodiment, a blockchain ledger 102 corresponding to the RFID label of a product may provide the history of the product from initial integrated circuit (IC) manufacturing all the way to its combination with the raw materials used to make the product (in whatever form those materials were in at the time, such as a nearly-finished product) which may be tracked through its own blockchain ledger 104 up until the point at which it is combined.

Once the blockchain ledgers 102, 104, 106, and 108 are combined (e.g., to resemble a fork, as best shown in FIG. 1), it also may be desirable to add certain other information to the combined blockchain ledger as a next step of the food chain process. For example, according to an exemplary embodiment, branding information 110 may be added to the combined product, after which the product may be distributed to retailers. In connection with the distribution of the product to retailers, retail information 112 may be added to the combined product. In an exemplary embodiment, this may allow the food chain ledger to be used to such purposes as inventory tracking at the retailer, allowing the retailer to know exactly which products are in stock and where, and allowing the retailer to know how long these products have been in stock. This information is extremely valuable to both the retailer and other interested parties upstream in the supply chain, such as the manufacturer. For example, by permitting such information to be passed up the supply chain, a manufacturer or distributor may be able to easily determine, from tracking all of the products having blockchain ledgers that they have been associated with, which products are selling well and which are not, or which are most likely to be returned, resold, donated, etc. This type of invaluable information may also allow for new types of business activity on the part of the manufacturer, distributor, or retailer. For example, a luxury brand of clothing may sell a limited run of designer clothing at a very low price with the caveat that the clothing cannot be sold or transferred to another individual or retailer, and may make use of the combined ledger system in order to determine if any future transfers are made.

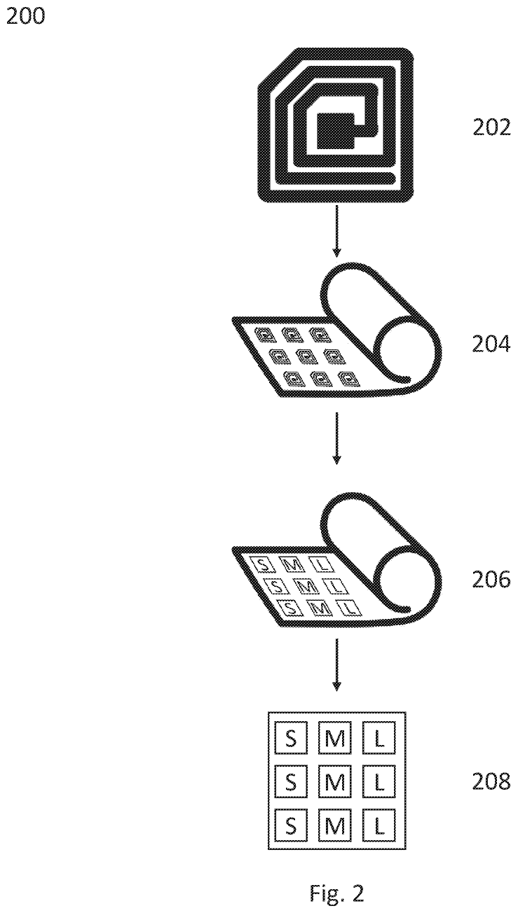

FIG. 2 provides an exemplary embodiment of a process flow diagram for the manufacturing of an RFID-equipped label 200. In a first step of a process flow diagram 200, an IC chip 202 may be produced. As chips 202 are assembled, certain records relating to the manufactured chips may be integrated into a blockchain ledger by the chip supplier, including any or all of the following: (a) the batch identifier (ID) of each of the chips 202, (b) the wafer ID, (c) the unique tag identification memory associated with and containing data about each chip 202 (which may, in Gen 2 RFID tags, be referred to as a TID), (d) the unique brand identifier associated with the chip supplier, and (e) a variable counter associated with the chip 202 and indicating its position in a production run. Other data may also be stored on the blockchain ledger related to the chip 202, which may be provided along with the RFID chip 202 to the chip recipient from the trusted chip manufacturer or supplier, all of which may, in an exemplary embodiment, be associated with timestamp and location information recorded in the blockchain ledger. The IC chip 202 may then be shipped, which may add a shipping event to the blockchain ledger or may update an associated shipping ledger, such as may be desired.

In a next step, the IC chips 202 may be incorporated into a roll of inlays 204. It is contemplated that, during this process, not all of the received IC chips 202 will successfully be incorporated into the inlay 204. For example, it is contemplated that some of the received IC chips 202 may be defective and/or may not be used (or even may be lost/undelivered). According to an exemplary embodiment, the shipping events of the ledger may be updated to show which IC chips 202 have been received, waste chip ledgers may be updated in order to show the defects, and other ledgers may be updated as appropriate.

In a next step, a plurality of labels 206 may be produced from the roll of inlays 204, and may be printed on and/or cut at this stage. Alternatively, further finishing or cutting steps may be performed at a later stage in the process, such as may be desired. Further, some of the RFID labels 206 may be identified as being unreadable or defective even after passing the previous stage, and such labels 206 may be identified and removed as appropriate, with the respective blockchain ledgers corresponding to those labels 206 being updated accordingly.

It is contemplated that one or more of manufacturing of the IC chips 202, incorporation of the IC chips 202 into a roll of inlays 204, and creation of RFID labels 206 may be performed by the same entity or by different entities, such as may be desired. For example, according to an exemplary embodiment, RFID labels may be manufactured into rolls such that the chips 202 are integrated into each label 206 on the roll. As part of this manufacturing process, additional information may be added to the blockchain for each RFID tag in each label 206 on the roll. Such additional information may include, for example, a unique roll ID for each roll of labels 206, an indication of whether the chip 202 or label 206 has been tested as being functional or nonfunctional (i.e., “good” or “bad”) or whether the chip 202 or label 206 has been tested as having an acceptable degree of functionality if multiple degrees of functionality are desired, as well as any other information that may be necessary in order to account for all of the chips 202 used in the manufacturing of the labels 206. As previously stated, it is also contemplated that the chips 202 may be tested prior to their integration with the labels 206, such that functional chips can be identified and used, and so that nonfunctional chips can be identified and properly disposed of. Additionally, each blockchain associated with each chip 202 may be updated, such that the blockchains associated with defective or nonfunctional chips identify those chips as defective or nonfunctional.

Further, once the labels 206 are manufactured in the form of rolls, the rolls may be assembled into cartons and the cartons assembled into pallets, which may then become the final product shipped to a customer for use with the end product. Further, the RFID tags may be associated with a roll ID associated with the roll of the RFID tag labels, which may be mapped to a particular carton ID based on the carton to which the roll has been added, which may in turn be mapped to a particular pallet ID based on the pallet to which the carton was added. The addition of these values to the blockchains associated with each RFID tag may allow information about the RFID tag to be tracked back to the initial chip ID and wafer ID, should it become necessary to verify the production process of the RFID chip all the way back to the trusted manufacturer or supplier of the labels. This lookup process may likewise be usable in a reverse fashion, such that a roll ID may be associated with a specific set of chips on the roll, thereby allowing the roll ID to be used in order to identify exactly which RFID chips have been used to form that roll of labels. If, for example, a roll has a particularly high defect rate, the defect rate may be identified and traced back to the supplier of the roll. Likewise, if a roll has a particularly low defect rate, the process allows that supplier to be identified and prioritized for future orders, etc.

In a next step 208, the labels 206 may be provided to a customer in a desired format and finalized. For example, labels 206 may be provided in a blank or partially printed form, and the customer may perform additional printing or processing to finalize the labels 206. In an exemplary embodiment, the customer may print and/or encode each of the received labels 206, also encoding location information therein as may be appropriate or desired to suit user need and/or preference.

Additionally, once the customer or other recipient has received labels 206, the customer may verify receipt of the labels through the blockchain ledgers associated with each label 206. Verification ensures that the production and shipment history of the label 206 is fully traceable from the initial stages of production of the chip 202 to the customer of the label 206. It is also contemplated to have situations wherein the labels 206 are only partially completed, or are finished elsewhere, which may also be specified in the production and shipment history of the label. For example, it may be desirable to provide blank labels, intended to be printed upon later or intended to be integrated within a product without any sort of printing being applied thereto, to one customer, while in another case it may be desirable to provide the customer with labels 206 that have already been printed upon and/or encoded prior to shipment. In such cases, wherein the labels may be printed and encoded prior to shipment, additional information such as the electronic product code (EPC) of the RFID may be integrated with the blockchain at this stage, as may be desired. For example, the EPC may be added to the label blockchain ledger prior to the label being associated with a roll ID, a case ID, and so forth.

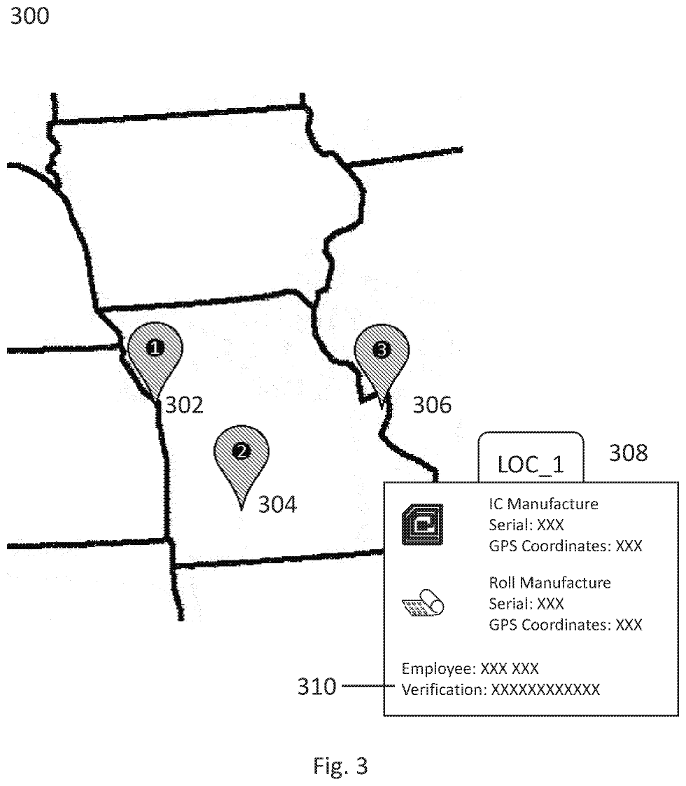

FIG. 3 shows an exemplary embodiment of a map showing the geographic location information associated with a food chain ledger 300, which may be accessible from a user interface of a user (not shown) through a user interface. According to an exemplary embodiment, each location in which the product or a portion of the product has been manufactured, sold, and/or distributed may be indicated as part of the ledger, and a user may be able to display this information as part of the resulting map.

For example, once the customer (or production facility or other destination) has received the rolls of labels 206, the location to which the labels 206 were shipped may first be integrated into the blockchain ledger for each label. The location information may be, for example, a GPS location of the facility or a mailing address, or any other geographical identifier as may be desired. It is also contemplated that the customer may have multiple locations in which the pallets of labels 206 may be shipped. For example, if the customer has a variety of end locations to which the labels may be shipped, the shipment of the labels 206 to these locations may be tracked via blockchain, and each of the customer's locations may host a secure node that may be used to read the product, and verify the receipt of the product and the location of receipt.

By way of further example, the map featured in FIG. 3 may show a product which has been manufactured and distributed within the state of Missouri. The map may track the path of the product, and optionally its predecessor raw materials through three different locations, marked as “1,” “2,” and “3” on the map, in this case corresponding roughly to Kansas City, Springfield, and St. Louis, and corresponding to reference numerals 302, 304, and 306, respectively.

A summary 308 of the activity grouped under location 1 (302) may be provided as part of the mapping interface, and in this example is shown in the bottom right corner of the map. According to an exemplary embodiment, the food chain ledger 300 associated with a particular product may indicate that a company based in location 1 (302) manufactured the RFID chip, and the inlay in which these chips were disposed, and the verification of a particular employee or agent 310 may be associated with this data. Each of the other locations shown on the map, namely location 2 (304) and location 3 (306), may also be selectable to provide similar information when selected. For example, location 2 (304) may represent a shipping terminal, and location 3 (306) may represent a retail location at which the product is sold or offered for sale.

Such a system may also support product status inquiries during production. For example, after a particular roll or carton has been scanned and associated with GPS coordinates, it may be represented on the map after being added to the food chain ledger associated with the roll. This may provide, for example, an indication to a downstream retailer as to which products are where and in what quantity. Upstream manufacturers may also be able to verify which products properly reached their destinations, thereby allowing those manufacturers to address any issues involving transportation if any should exist.

Further, once the pallet has reached the end location, it may be desirable to have a specific employee (or employees, or agent(s)) of the company be responsible for inspecting the labels 206 and updating the blockchain ledgers associated with each label. According to an exemplary embodiment, it is also contemplated that the company may have specific devices (e.g., an automated receipt process), which may be able to inspect the labels and update the blockchain ledgers accordingly. In an exemplary embodiment, a blockchain ledger may be updated to show the identifying information for a particular authorizing employee or agent, which may update the ledger to show, for example, “Received—Employee 306.” In such an exemplary embodiment, once the case ID, pallet ID, and/or roll ID is received, one of the identifiers (such as a roll ID) may be transferred to this individual ID for the employee or agent such that the roll ID or other identifier can be tracked via the blockchain ledger. Individual label IDs may also be directly transferred or may be updated directly to include the employee ID information or may instead simply inherit it from the roll ID information or other identifying information.

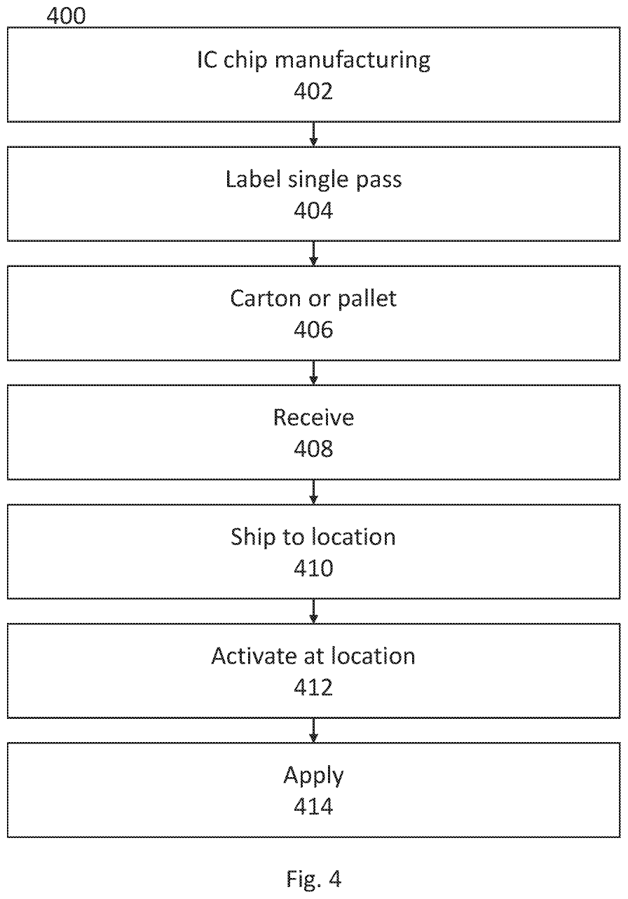

FIG. 4 displays an exemplary embodiment of a process flow diagram for a food chain system 400 of the present invention, from an initial manufacturing step for an RFID label 402 to a final step of applying the label to a particular product 414, after which the product (rather than the label) may be tracked, as may be desired. More specifically, at step 402, an IC chip may be manufactured 402, which may result in certain information being added to a cloud blockchain ledger associated with the chip, such as a batch ID, a wafer ID, a TID (and any other identification information), an intended shipping destination, and a chip counter indicating the chip's position in a production run, as may be desired. Specifically, in an exemplary embodiment of the manufacturing process, a set of wafers/chips may be produced with a unique TID and a unique brand ID (or BID) on the die. Each wafer may also have a unique wafer ID associated therewith, along with any other identifying information that may be appropriate. Such identifying information may be provided as unalterable data in the chip.

In a next step 404, a label roll may be initially prepared by, for example, integrating the IC chips produced in the previous step 402 into an inlay or roll of inlays. According to an exemplary embodiment, this roll then may be updated to provide a roll ID as well as a TID/BID of chips within the roll, and mapping information. Specifically, in step 402, the TID of the chips used in manufacturing the roll may be tracked and recorded, and waste material may be contained. For example, bad product may be identified through an appropriate testing method, and defective products may be eliminated. Therefore, each roll may be provided with a unique ID and an association with all known good labels in the roll. This information then may be provided in the form of a roll ledger, which may contain the TID/BID of the labels. Likewise, a waste ledger also may be created in order to keep track of all the bad or defective chips that needed to be discarded, or otherwise went unused or are missing.

In a next step 406, the rolls may be assembled into a carton and/or pallet, and the roll IDs of the rolls in the cloud blockchain roll ledger may be associated with the carton ID and stored within a cloud blockchain carton ledger (along with a GPS location if so desired), and the carton ID may then be stored in a pallet ledger along with a pallet ID, a customer ID, and a supplier ID, along with any other information as may be desired.

In a next step 408, the pallet, once shipped, may be received and the receipt may be stored in a receipt ledger. More specifically, the receipt ledger may store, without limitation, a date and time of receipt, a received pallet ID, a carton ID for each carton on the pallet, a GPS location or other location information, as well as a supplier ID indicating the point of origin of the product. As such, once the customer receives the pallet or carton, the system may log the GPS location of the site of receipt (or other location information) in order to tie it to a receipt log.

In a next step 410, a shipment ledger may also be created, identifying how the pallet has been shipped to the customer. In an exemplary embodiment, it is contemplated to have step 410 provided as part of an initial shipment phase, such that, rather than having the customer receive all pallets at a single location, multiple pallets may be shipped to multiple different sites for the same customer, if so desired. The shipment ledger may include, without limitation, a pallet ID, a case ID, a location ID (which may be GPS) or any other identification information as may be desired.

In a next step 412, as the pallets are received at the desired location, they may be activated at the location. According to an exemplary embodiment, upon receipt at an application location, the location may receive the pallet and scan the shipment, thereby causing GPS location to be captured. Finally, at step 414m the labels may be printed, encoded, and/or applied to the corresponding products. For example, in a printing step and then an encoding step (or a printing and encoding step if both are to be performed by the same device), a printer may be activated and may be tasked with printing label material on a roll. The labels may then be encoded. As part of this process, the roll ID for each of the label rolls that may be fed into the printer may be scanned, and each of the TIDs of the individual labels may be read, so that each can be validated. The printer may then encode a GPS location (or other geo-location information) when encoding the RFID in the label, along with a printer ID, which may be added to a printer ledger or label ledger, such as may be desired. By way of example, a printer ledger may include, without limitation, a printer ID, a roll ID, the TID/BID of each label associated with the roll that passes through the printer, a counter value for number of labels that pass through the printer, a GPS location, an encoded EPC, and any other data that may be desired.

In a final application step, a label may be applied and associated with a particular product. Activation may be manual, such that the label may be read by a trusted employee or agent after being applied or may even be hand-applied by the trusted employee or agent. The employee or agent may read and scan the label, adding a verification to a cloud blockchain associated with the label, in order to properly activate it. Subsequent updates to the location of the product may then be added to the blockchain based on later access, and as so desired.

In relation to the trusted application of the label to a particular product, once a specific roll ID ownership value is assigned or transferred to an individual ID, the individual may then encode certain further information on the blockchain ledgers, optionally with specific hardware, and optionally after performing certain other actions, as may be desired. For example, an individual may first use a dedicated hardware system in order to verify the accuracy of each roll ID, as well as any other details stored on the blockchain. The same dedicated hardware system may also be used in order to perform chip testing, and each RFID tag encoded in each label, or some appropriate selection of RFID tags in the label roll, may be tested in order to ensure that the RFID tags can be properly read. Damaged or defective RFID tags may be removed from the process, and the blockchain updated accordingly.

According to an exemplary embodiment, a customer hardware system may incorporate a printer, which may be used to print any variable information on the labels that may be desired. For example, if the labels are blank, the printer may be used to print any and all information on the labels that may be desired. Alternatively, variable information may be printed on just a portion of the labels in order to supplement unchanged information provided on the labels since the previous step, if the labels were prepared in this manner in the previous step. The label printer used by the customer may also be connected to an encoder or another hardware device configured to record the variable data in the blockchain ledgers.

The customer hardware system may further include an encoder, which may be used to encode information in the RFID tag of the label. The encoder may be provided before or after the printer (e.g., upstream or downstream of the printer), or may be provided concurrently with the printer in that some printer tasks may be performed beforehand or afterward. For example, labels may be printed upon, encoded, and separated from the web if provided in a continuous format. The encoded information may then be stored in the blockchain ledger in some form. For example, all the encoded information may itself be stored in the blockchain ledger, which may allow for the information to be easily accessed by tracing the product's history. In another embodiment, only a selection of the encoded information, or an indication that the information has been successfully encoded, may be stored in the blockchain.

The customer hardware system may also include a location encoder, which may encode the location at which the label was printed and encoded. The location encoder may be part of the encoder, or may be a separate device. According to an exemplary embodiment, the location encoder may make a live retrieval of the current location with every encoding (e.g., via GPS), or may encode a predetermined location. For example, in one embodiment, the address of the factory may be encoded; whereas, in another embodiment, a pre-recorded GPS coordinate or other location indication may be encoded without such location being checked first. The encoded location may then be added to the blockchain ledger, along with the other information associated with the RFID label, in such a manner as to tie it to both the roll ID (and/or the individual label ID) and the individual ID of the customer employee.

According to an exemplary embodiment, it is also contemplated to have a combination printing and encoding machine, or a machine that performs some combination of printing and encoding. The combination printing and encoding machine may perform the functions of printing, data encoding, and/or location encoding after verifying the individual ID and the roll ID to ensure that each was proper.

According to an exemplary embodiment, it is also contemplated that a customer may be making use of already printed labels (e.g., printed labels that have not yet been encoded), already encoded labels (e.g., encoded labels that have not been printed or which do not feature a finalized print), and/or labels that have already been printed and encoded. It is contemplated that printing and encoding may be performed as a part of the manufacturing of the roll, if desired. Alternatively, it is contemplated to have a service bureau or other intermediate company perform the labeling and printing, as may be desired. Further, if a service bureau performs any of the intermediate steps, such information may also be indicated on the blockchain in a similar matter to the method previously discussed to ensure full accountability at each step in the supply chain.

Once the customer has completed the printing and encoding process, an authorized individual at the customer (who may be, for example, a trusted employee or agent of the manufacturing company) may apply the digital identity to the physical product. In one exemplary embodiment of a food chain system, the rolls may be fully traceable up until this point, with the rolls being assigned to this employee or agent and validated by the printer and encoder machine node. After this point, the focus may be on the individual labels, as the labels may be applied to the actual physical products with which they will be associated and incorporating such information into the blockchain ledger associated with each product. Chain of custody protocols could also be used to ensure that all the labels are accounted for as part of the process to maintain integrity of the system. User IDs, hardware encryption, or other authentication details can also be used.

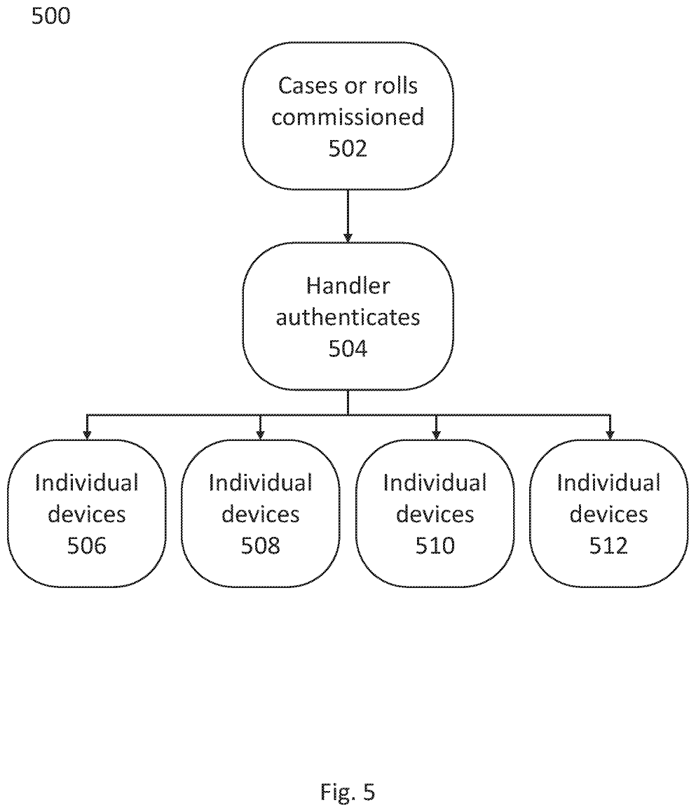

FIG. 5 is an exemplary embodiment of a process flow diagram for a verification system 500. According to an exemplary embodiment, once the cases or rolls have been commissioned at step 502, they may be authenticated by a handler at step 504, through some method of authentication or multi-factor authentication. For example, authentication may include, without limitation, biometric authentication, a password, a physical authentication device, or any other authentication device or technique. GPS information may also be associated with an authenticated product at this step. This information may then be read by one or more of a plurality of individual devices 506, 508, 510, 512 further down the supply chain, such as a printer, an automated applicator, a hand application tool, or any other devices which may interact with the product or with the blockchain, as may be desired. Such a process may, as discussed above, be used to connect the roll ID for the roll of labels, the tag ID for an individual tag, the GPS locations that the two had been taken through, the authentication key (e.g., a biometric authentication key), and the timeline of transfer of ownership, in order to allow this information to be used to authentically connect digital identifiers to physical items.

In order to ensure that the physical products are properly associated with the RFID tag and with the blockchain ledger associated with that RFID tag, an exemplary embodiment of the food chain system may have a process for incorporating the two. For example, once a particular physical product is assigned a specific label, or during the manufacturing process, a final time stamp may be applied to the blockchain ledger associated with the RFID tag of the label, corresponding to the time at which the tagged product was scanned and read during the manufacturing process or a time immediately after labeling. This final timestamp may provide for the traceability of the label all the way back through the label supply chain, to the first production of the integrated circuits.

Once this has occurred, the manufacturer may, upon reading the tagged product and time stamp, create a verification report to provide the product with a cohesive digital identity. For example, according to an exemplary embodiment, a verification report may include verification of one or more of, or all of, the following: (a) that the labels have come from a trusted source; (b) that the commissioned labels have been provided to the correct manufacturing location; (c) that the labels have been updated by a trusted employee or agent; (d) that the labels have been properly encoded at a defined location; (e) that the labels have been applied to a product at a defined location (by geolocation or otherwise) as overseen by the trusted employee or agent; and (f) that the product's digital identity has been finalized and activated for downstream supply chain uses.

Once this persistent digital identity has been created, others may be able to add to the blockchain ledger associated with a particular product. For example, once the product has an activated digital identity, it may be updated with timestamp and location information showing that it has been provided to a retailer, timestamp and location information of an original purchase by a first party, information showing that the first party donated the product to, for example, a consignment store, information showing that it was then purchased from the consignment store by a second party, and so on and so forth. In some cases, a product having a digital identity may be updated even though it hasn't changed hands. For example, a digital identity of a product may be updated if it is returned or exchanged (e.g., clothing of an improper size), or may even be updated when it is taken to particular places (e.g., a user that travels to a foreign country may have their products “check in” to those foreign countries to show where the products have previously been).

In an exemplary embodiment, the blockchain ledger associated with a particular RFID tag in a label may also be combined with a pre-existing blockchain associated with a product, or with any other component of the process. For example, a particular product may be designated by a blockchain ledger as being associated with the raw materials used to make the product. Further, companies providing transportation or labor may also have their own blockchain ledgers indicating what was done and when, which may be reconciled with the blockchain ledger of the RFID tag and/or of the raw materials.

In some embodiments, a ledger, such as the IBM Food Trust, is utilized to provide enhanced visibility and traceability of products, such as food products. Advantageously, a system can provide for item-level identification in large quantities by using, for example, auto-identification data capture (AIDC) technologies. Such technologies may include, for example, radio frequency identification (RFID) tags, barcodes, QR codes, including the GS1 Digital Link standard, data matrix codes, or the like.

In some embodiments, a system utilizes pre-authorized identifications at a point of manufacturing or at subsequent steps in the supply chain. In some embodiments, a pre-authorized identification does not yet exist, for example, when a new product is introduced or a new system user (e.g., a manufacturer, supplier, distributor, retailer, or other entity) joins the system. In such embodiments, an authorized identification can be produced and shared with other participants of the system. In this manner, the authorized identification will, in subsequent usages, be considered a “pre-authorized identification.” For example, retailers, suppliers, and other companies are utilizing the IBM Food Trust, built on Hyperledger Fabric (a blockchain framework implementation and project hosted by The Linux Foundation), to trace products through the supply chain. In some embodiments, companies may make, use, and share Food Trust-ready identifications to facilitate the tracking and tracing of components and products through the supply chain. For example, specific identifiers in the IBM Food Trust data structure could be pre-loaded in an exemplary system in order to promote adoption of such a system. Advantageously, an open system utilizing such pre-authorized identifications can provide for enhanced data integrity that can be readily verified by any and all users of the system.

In some embodiments, certain protocols and data structures exist within a system framework for the creation of new identifiers that will be shared with and used by other users or participants of the system. Such protocols and data structures can ensure that new identifiers created within the system are unique and provided in a standardized format, which in turn can ensure data integrity by preventing redundant and/or ambiguous use of new identifiers. In such an exemplary implementation, identifiers (IDs) that are specific to a given system (such as the IBM Food Trust, in one example) are generated. Protocols or other rules may exist to mandate that such IDs be contained within a specified range, and thus any IDs that fall outside of the range of those associated with the particular system could be identified and interrogated for additional information.

Next, in some embodiments, pre-authorized IDs, or those that are generated according to specified protocols and rules as discussed herein, are then loaded to the system and/or added to the blockchain. This step may occur at any point in the supply chain. For example, such IDs may be added at a point of manufacture (e.g., upon receipt of raw materials, upon completion of manufacturing activities, upon shipment of finished products, etc.), during transportation or to indicate the product has reached a particular stage in the supply chain (e.g., shipment to or receipt by a distributor or retailer), or at any other stage of the supply chain. In some embodiments, product details may be associated with a product or group of products (e.g., product details may be added to a corresponding blockchain ledger) at a desired or point of data capture downstream. For example, an ID (such as for a product, carton, or pallet) can be read by various means understood in the art. For example, the ID may be read by any one or more of interrogating an RFID tag or scanning a bar code, QR code, data matrix code, or the like. at an inbound data capture location, and then associated/added to the blockchain once the ID is processed for shipment. By associating such product details with a blockchain, historical data related to the ID can also be maintained.

In some embodiments, a central or otherwise designated entity can have approval, oversight, or other supervision over item-level data flow for all new products entering the system prior to an associated ID being designated or considered an authorized ID of the system. Advantageously, such enhanced item-level data flow can provide stronger data integrity, which in turn can help drive wider adoption of such a system.

According to some embodiments, the system is implemented using auto-identification and data capture (AIDC) technologies, including one or more of radio frequency identification (RFID) tags, barcodes, QR codes, including the GS1 Digital Link standard, data matrix codes, digital watermarks, and the like. Such a system could maintain Electronic Product Code Information Services (EPCIS) compliance, and/or any other applicable industry standard.

In some embodiments, RFID components may be entity-specific, for example by using on-chip identifiers. Such use of specific and related RFID elements may provide enhanced security as the RFID information cannot be accessed by outside sources other than participants (and, optionally, designated participants only) of the system. In still other exemplary embodiments, unique serialization schemes may be created for specific entities and/or for specific systems.

Advantageously, implementations of barcodes, QR codes, data matrix codes, digital watermarks, or other printable, two-dimensional indicia capable of being scanned, may facilitate deployment of the systems of the present disclosure. For example, such two-dimensional indicia capable of being scanned may be used while system participants invest in any necessary capital and/or infrastructure for implementation using RFID technologies.

Moreover, redundant use of various AIDC technologies in conjunction with the systems described herein may provide enhanced data integrity. For example, a product or item may contain both an RFID tag and one or more two-dimensional indicia capable of being scanned (e.g., a barcode, QR code, data matrix code, digital watermark, or the like). Advantageously, should a system user or participant encounter difficulty in reading the RFID tag for any reason (e.g., the RFID tag is faulty or defective either initially or through damage incurred during movement through the supply chain, the RFID tag becomes dislodged and/or misplaced during movement through the supply chain, an RFID interrogator reading the RFID tag is faulty or defective, interference with surrounding objects or materials prevents successful interrogation of the RFID tag, or any other reason), redundant information may be obtained from scanning one or more two-dimensional indicia also contained on the product or item. Likewise, the opposite may be true; that is, where a two-dimensional indicia is no longer capable of being scanned (for whatever reason), an RFID tag containing redundant information may be interrogated to enable the system to perform additional steps contemplated herein.

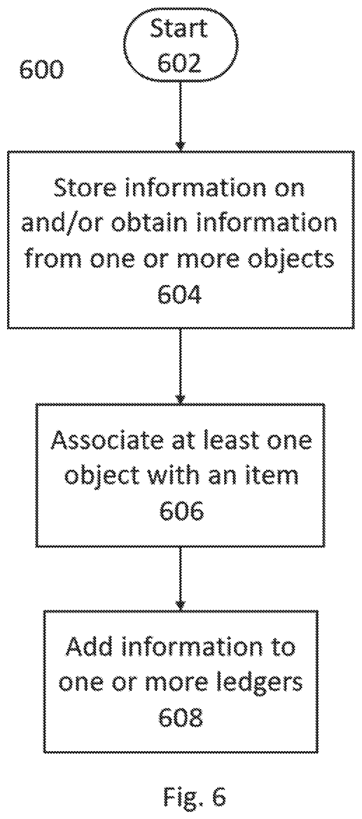

FIG. 6 is an exemplary embodiment of a process flow diagram for a method and system of tracking a product 600. According to an exemplary embodiment, a method for tracking an item begins at step 602. Any item or product (or component or ingredient thereof) may be tracked according to the methods of the present disclosure, as may be desired. As illustrated, information may be stored on one or more objects and/or information may be obtained from one or more objects at 604. In some embodiments, the one or more objects comprise auto-identification and data capture technologies, which may be selected from the group consisting of radio-frequency identification (RFID) tags, barcodes, QR codes, data matrix codes, and digital watermarks. Thus in some embodiments, storing information on the one or more objects may comprise writing information to an RFID tag using an RFID encoder and/or printing two-dimensional indicia capable of being scanned (e.g., a barcode, QR code, data matrix code, or digital watermark) on a label, as would be understood by a person of ordinary skill in the art. In some embodiments, obtaining information stored on the one or more objects comprises one or more of interrogating an RFID tag, scanning a barcode, scanning a QR code, scanning a data matrix code, or scanning a digital watermark.

In some embodiments, the information stored on the one or more objects comprises one or more authorized identifications associated with the item being tracked. In some embodiments, the one or more authorized identifications may also, or alternatively, be associated with one or more entities (e.g., a farmer, processor, manufacturer, distributor, retailer, etc.). In some embodiments, at least one of the authorized identifications is stored in a system database. Thus, prior to storing the one or more authorized identifications on the one or more objects, a system user must procure the one or more authorized identifications from the system database.

In some embodiments, the system database may not contain an appropriate authorized identification. For example, a manufacturer may wish to introduce a new product (i.e., item to be tracked), or a manufacturer may procure raw ingredients from a new source (and this need an authorized identification associated with the new entity). Thus, a system user may create at least one new identification to generate an authorized identification. In such embodiments, the system user may first need to obtain approval from a database administrator, for example, before using the at least one new identification. In some embodiments, once the system user has created at least one new identification, and optionally received approval from an administrator, the system user shares the at least one new identification with other system users. In some embodiments, the system user or a database administrator adds the at least one new identification to the system database.

Next, at step 606, at least one of the one or more objects is associated with the item being tracked. In some embodiments, the at least one object is a label that contains one or more of an RFID tag, a barcode, a QR code, a data matrix code, or a digital watermark. The label may be secured to, attached to, or otherwise paired with the item being tracked. In some embodiments, the label is secured to, attached to, or otherwise paired with packaging associated with the item. In embodiments in which the label comprises scannable indicia (e.g., a barcode, a QR code, a data matrix code, or a digital watermark), the label is placed on the item being tracked, or on packaging associate with the item being tacked, in a location that is readily accessible and visible. For example, if a case of wine is being tracked, a label containing the scannable indicia should be placed on an outer surface of the case so that the scannable indicia may be scanned.

In some embodiments, one or more objects may be associated with the same item. For example, considering the case of wine, a label placed on an outer surface of the case may include both an RFID tag and one or more scannable indicia. Alternatively, the RFID tag may be included in a first label and the one or more scannable indicia may be included in one or more additional labels. Thus, information associated with the item may be obtained through alternate means. For example, the RFID tag on the label may be interrogated by an RFID reader, or a barcode contained on the label may be scanned by a barcode reader. In some embodiments, redundant information is stored on the RFID tag and the scannable indicia. Thus, should a user encounter difficulty in either reading information stored on the RFID tag (for example, interference from the surrounding environment or problems with an RFID reader may prevent a successful read of the tag) or in scanning the scannable indicia (for example, the scannable indicia may not be within a scanner's line-of-sight), then alternate means exist for obtaining information associated with the item (e.g., reading the RFID tag or scanning the scannable indicia, as the case may be).

It is also contemplated that, the RFID tag may contain at least some information that is not also contained in the scannable indicia. Likewise, the scannable indicia may contain at least some information that is not also contained on the RFID tag. In this manner, a greater amount of information may be associated with the item being tracked.

In some embodiments, a new object is associated with an item being tracked at different stages of the supply chain. For example, a first object containing a first piece of information may be associated with the item at a point of manufacturing or initial processing. Next, one or more additional objects each containing one or more additional pieces of information may be associated with the item at each point of shipment and/or receipt the item. Thus, a winemaker may associate a label with an RFID tag and/or other scannable indicia on a case of wine before shipping the case to a distributor. Next, the distributor may associate a second label with an RFID tag and/or other scannable indicia on the case of wine after receiving the case from the winemaker. The distributor may then send the case of wine to a retailer, who in turn adds a third label with an RFID tag and/or other scannable indicia to the case of wine before selling to a consumer. In this manner, information related to each stage of the supply chain may be associated with the item being tracked at each stage. Alternatively, information related to each stage of the supply chain may be stored on a single object (e.g., RFID tag) associated with the item.

With continued reference to FIG. 6, once an object (such as an RFID tag or other scannable indicia) has been associated with an item being tracked, information contained on the object is added to one or more ledgers associated with the item at step 608. In some embodiments, at least one of the one or more ledgers is associated with one or more entities, such as a manufacturer, distributor, retailor, etc. In some embodiments at least one of the one or more ledgers is an open or public blockchain. In some embodiments at least one of the one or more ledgers is a permissioned blockchain. Information may be added to the one or more ledgers through use of a computer network appropriate configured to add such information to the one or more ledgers, as would be understood by a person of ordinary skill in the art.

When information is stored on one or more objects at various stages of the supply chain (for example, a new object is associated with the item at different stages, or information related to different stages is added to a single object associate with the item), the information may be added to the one or more ledgers at each stage of the supply chain. That is, as information is stored on the one or more objects, it is also added to the one or more ledgers. Advantageously, such a method may provide updated information about the item throughout all stages of the supply chain.

Alternatively, information may be stored on the one or more objects at different points in time (e.g., as the item moves through the supply chain), but the stored information may not be added to the one or more ledgers until a subsequent time. For example, as part of a retailer's receiving process, the retailer may obtain all the information stored on the one or more objects and add the information to the one or more ledgers at that time.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for tracking an item, comprising:
storing information on one or more objects;
associating the one or more objects with the item; and
adding the information to one or more ledgers associated with the item.

2. The method of claim 1, where the one or more objects comprise auto-identification and data capture technologies.

3. The method of claim 2, where the auto-identification and data capture technologies are selected from the group consisting of radio-frequency identification (RFID) tags, barcodes, QR codes, data matrix codes, and digital watermarks.

4. The method of claim 3, further comprising obtaining the information stored on the one or more objects.

5. The method of claim 4, where obtaining comprises one or more of interrogating an RFID tag, scanning a barcode, scanning a QR code, scanning a data matrix code, or scanning a digital watermark.

6. The method of claim 3, where the associating step comprises securing an RFID tag to the item or packaging associated with the item.

7. The method of claim 6, where the RFID tag is part of an RFID label further comprising printed indicia comprising one or more of a barcode, a QR code, a data matrix code, or a digital watermark.

8. The method of claim 7, further comprising storing redundant information on the RFID tag and the one or more barcode, QR code, data matrix code, or digital watermark.

9. The method of claim 1, where the information comprises one or more authorized identifications associated with one or more of the item and one or more entities.

10. The method of claim 9, further comprising procuring at least one of the authorized identifications from a system database.

11. The method of claim 9, further comprising creating at least one of the authorized identifications to generate at least one new identification.

12. The method of claim 11, further comprising obtaining approval to use the at least one new identification.

13. The method of claim 11, further comprising at least one of sharing the at least one new identification with system users and adding the at least one new identification to a system database.

14. A system for tracking an item, comprising:
one or more objects associated with the item;
one or more authorized identifications stored in each of the one or more objects; and
one or more ledgers associated with the item.

15. The system of claim 14, where the one or more objects comprise auto-identification and data capture technologies selected from the group consisting of radio-frequency identification (RFID) tags, barcodes, QR codes, data matrix codes, and digital watermarks.

16. The system of claim 14, where at least one of the one or more objects comprises an RFID label including an RFID tag and the system further comprises an RFID reader configured to interrogate the RFID tag.

17. The system of claim 16, where the RFID label further comprises printed indicia comprising at least one of a barcode, a QR code, a data matrix code, or a digital watermark and the system further comprises a scanner configured to scan at least one of the barcode, QR code, data matrix code, or digital watermark.

18. The system of claim 14, where at least one of the one or more authorized identifications is stored in a system database.

19. The system of claim 14, where the one or more authorized identifications are standardized according to defined protocols.

20. The system of claim 14, further comprising a computer network configured to add at least one of the one or more authorized identifications to at least one of the one or more ledgers.
